(19) United States
(12) Patent Application Publication
(10) Pub. No.: US 2016/0014539 A1
(43) Pub. Date: Jan. 14, 2016

(54) EARPHONE AND SOUND CHANNEL CONTROL METHOD THEREOF

(71) Applicant: Acer Incorporated, New Taipei City (TW)

(72) Inventor: Neng-Wen YEH, New Taipei City (TW)

(21) Appl. No.: 14/663,820

(22) Filed: Mar. 20, 2015

(30) Foreign Application Priority Data
Jul. 9, 2014 (TW) 103123577

(51) Int. Cl. H04S 7/00; H04R 1/10

(52) U.S. Cl. CPC H04S 7/00; H04R 1/10

(57) ABSTRACT

An earphone is provided. The earphone includes a first speaker, an audio processor, a sensor, and a controller. The audio processor provides a left sound channel signal and a right sound channel signal according to a stereo signal. The sensor senses a movement path of the earphone. The controller selectively provides one of the left sound channel signal and the right sound channel signal to the first speaker according to the movement path.

### CROSS REFERENCE TO RELATED APPLICATIONS

This Application claims priority of Taiwan Patent Application No. 103123577, filed on Jul. 9, 2014, the entirety of which is incorporated by reference herein.

### BACKGROUND OF THE INVENTION

1. Field of the Invention

The invention relates to an earphone, and more particularly to an earphone capable of automatically selecting the sound channels.

2. Description of the Related Art

Nowadays, the sizes of portable electronic devices are getting smaller, and more and more functions can be provided. Because of their convenience, users prefer to use the portable electronic devices to listen to music and watch videos. In general, when playing multimedia applications, a user will use the built-in speaker of the portable electronic device or wear earphones to listen to the sound played by the applications.

Currently, in the design of earphone devices, the left and right sound channels are designed on the same device, in order to achieve a stereo effect. The user needs to identify which is the left/right sound channel earphone through the text (L/R) on the earphone devices, or by color.

Therefore, an earphone with an automatic channel selection function is desired, such that the user can directly wear the earphone without manually identifying the sound channels of the earphone.

### BRIEF SUMMARY OF THE INVENTION

An earphone and a sound channel control method thereof are provided. An embodiment of an earphone is provided. The earphone comprises a first speaker, an audio processor, a sensor, and a controller. The audio processor provides a left sound channel signal and a right sound channel signal according to a stereo signal. The sensor senses a movement path of the earphone. The controller selectively provides one of the left sound channel signal and the right sound channel signal to the first speaker according to the movement path.

Furthermore, an embodiment of a sound channel control method for an earphone is provided. A left sound channel signal and a right sound channel signal are provided according to a stereo signal. A movement path of the earphone is sensed. One of the left sound channel signal and the right sound channel signal is selectively provided to a first speaker of the earphone according to the movement path.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a multimedia playing system according to an embodiment of the invention;

FIG. 2 shows an earphone according to an embodiment of the invention;

FIG. 3 shows a schematic illustrating the course taken by the earphone being worn by the user according to an embodiment of the invention;

FIG. 4 shows a schematic illustrating the course taken by the earphone being worn by the user according to another embodiment of the invention; and

FIG. 5 shows a sound channel control method for an earphone according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

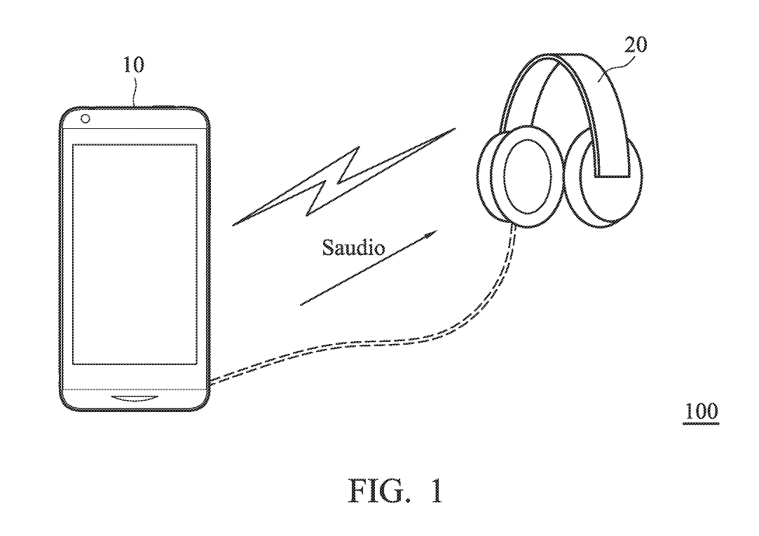

FIG. 1 shows a multimedia playing system 100 according to an embodiment of the invention. The multimedia playing system 100 comprises a portable electronic device 10 and a circumaural-type earphone 20. When the portable electronic device 10 performs an application (e.g. a multimedia program), the portable electronic device 10 transmits a stereo signal Saudio provided by the application to the earphone 20 via a wire or wireless manner. Next, according to the stereo signal Saudio, the earphone 20 can generate a left sound channel signal Ch_L and a right sound channel signal Ch_R. Simultaneously, by detecting the behavior of a user wearing the earphone 20 (i.e. the movement path of the earphone 20), the earphone 20 can automatically identify the left and right ears of the user, and provide the correct sound channel signals to the corresponding speakers for playing. Therefore, by detecting the behavior of the user with an earphone, it is automatically determined whether the channel setting of the earphone needs to be adjusted, so as to provide the correct channel signals to the user's left and right ears.

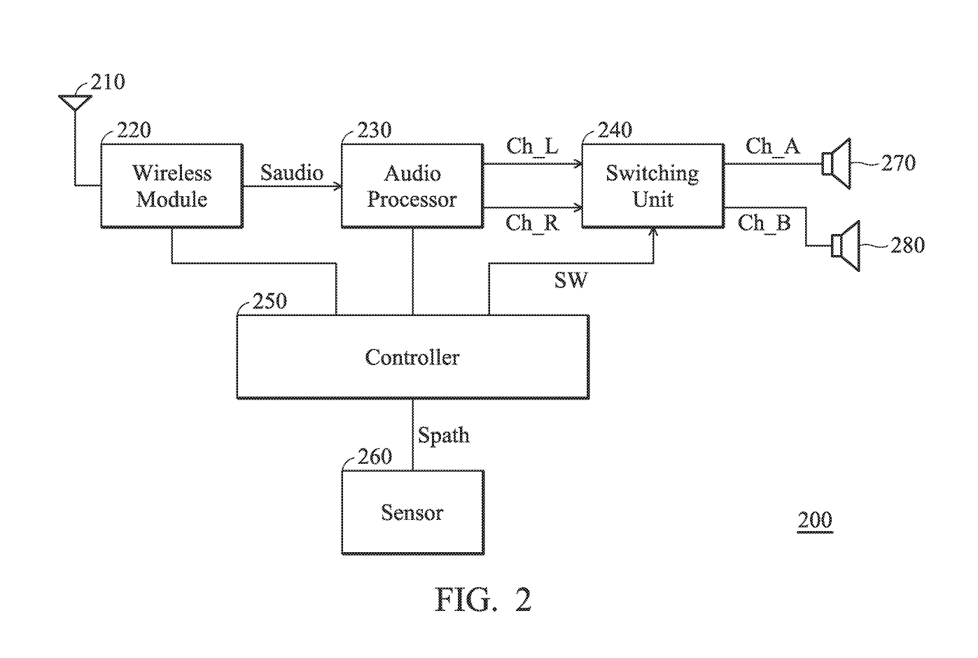

FIG. 2 shows an earphone 200 according to an embodiment of the invention. The earphone 200 comprises an antenna 210, a wireless module 220, an audio processor 230, a switching unit 240, a controller 250, a sensor 260, a speaker 270 and a speaker 280. The controller 250 controls the wireless module 220 and the antenna 210 to perform a wireless connection with a wireless device (e.g. the portable electronic device 10 of FIG. 1), so as to receive the stereo signal Saudio from the wireless device. In one embodiment, the earphone 200 obtains the stereo signal Saudio via a transmission line (e.g. an audio cable). Next, according to the stereo signal Saudio, the controller 250 controls the audio processor 230 to generate a left sound channel signal Ch_L and a right sound channel signal Ch_R, and to transmit the left sound channel signal Ch_L and the right sound channel signal Ch_R to the switching unit 240. In one embodiment, the audio processor 230 is a CODEC. Furthermore, when a user takes the earphone 20 and wants to wear the earphone 20, the sensor 260 can detect the movement direction and the movement distance of the earphone 20, so as to provide information having a movement path Spath to the controller 250. In the embodiment, the sensor 260 may be a gravity sensor, a gyroscope, or an E-compass. Thus, the controller 250 can determine a relative position between the user and the speakers 270 and 280 according to the movement path Spath. In other words, the controller 250 can determine which one of the speaker 270 or the speaker 280 is near the user's left ear and which one is near the user's right ear, according to the movement path Spath. Next, the controller 250 provides a control signal SW to the switching unit 240, so as to generate an audio signal Ch_A to be transmitted to the speaker 270 and an audio signal Ch_B to be transmitted to the speaker 280 according to the left sound channel signal Ch_L and the right sound channel signal Ch_R. For example, when determining that the speaker 270 is near the user's left ear and the speaker 280 is near the user's right ear, the controller 250 can provide the control signal SW to the switching unit 240. Thus, in response to the control signal SW, the switching unit 240 assigns the left sound channel signal Ch_L as the audio signal Ch_A, and assigns the right sound channel signal Ch_R as the audio signal Ch_B. Conversely, when determining that the speaker 270 is near the user's right ear and the speaker 280 is near the user's left ear, the controller 250 can provide the control signal SW to the switching unit 240. Thus, in response to the control signal SW, the switching unit 240 assigns the left sound channel signal Ch_L as the audio signal Ch_B, and assigns the right sound channel signal Ch_R as the audio signal Ch_A. In one embodiment, the earphone 20 may be an earhook-type or earbud-type single-ear earphone that only has a speaker, e.g. only comprising the speaker 270, and the controller 250 can provide the correct sound channel signal to the single speaker according to the movement path Spath.

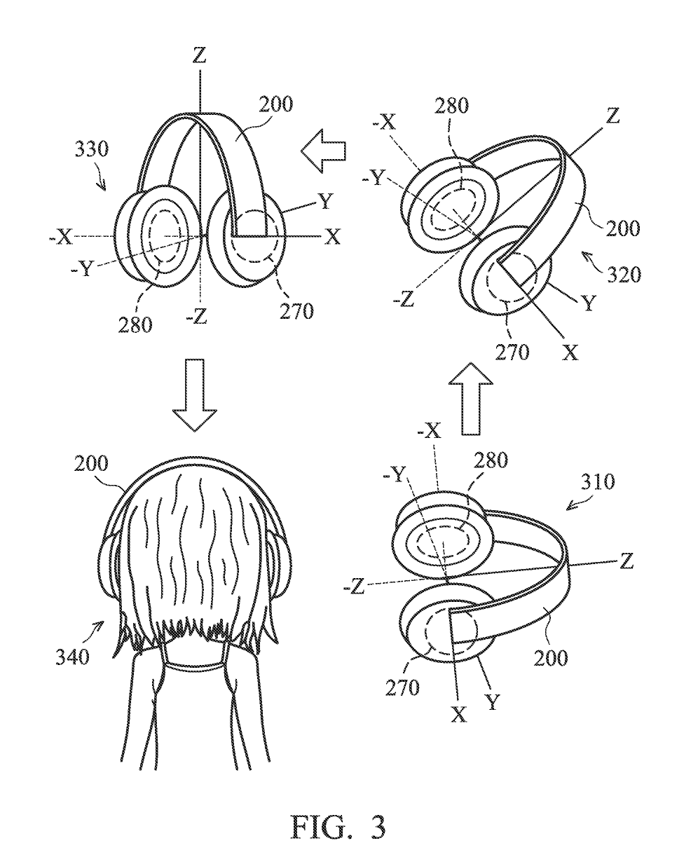

FIG. 3 shows a schematic illustrating the course taken by the earphone being worn by the user according to an embodiment of the invention. Referring to FIG. 2 and FIG. 3 together, before the user takes the earphone 200, the sensor 260 obtains three-dimensional (3D) data TD1 of a first position for the earphone 200 (as shown in label 310), wherein the 3D data TD1 comprises axis information regarding X axis, Y axis and Z-axis of the earphone 200. Next, the user takes the earphone 200 and puts it on his head (as shown in label 340) via a second position (as shown in label 320) and a third position (as shown in label 330) in sequence. Moreover, the sensor 260 also obtains the 3D data TD2 corresponding to the second position, the 3D data TD3 corresponding to the third position, and the 3D data TD4 that the earphone 200 has been worn, respectively. Thus, the sensor 260 provides the movement path Spath to the controller 250 according to the 3D data TD1-TD4. Therefore, when the movement of the earphone 200 is stabilized, the controller 250 can determine that the earphone 200 is being worn completely, and the controller 250 can determine that the user takes and wears the earphone 200 via his right side according to the movement path Spath. Next, the controller 250 provides the control signal SW to the switching unit 240, so as to assign the right sound channel signal Ch_R as the audio signal Ch_A and assign the left sound channel signal Ch_L as the audio signal Ch_B. Thus, the user's right ear can listen to the right sound channel signal Ch_R via the speaker 270, and the user's left ear can listen to the left sound channel signal Ch_L via the speaker 280.

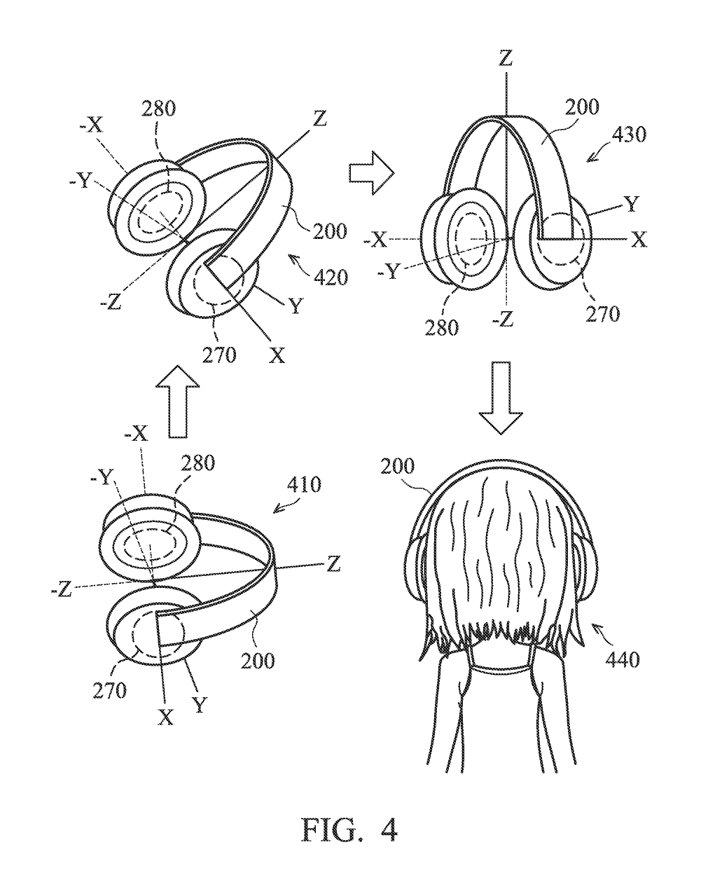

FIG. 4 shows a schematic illustrating the course taken by the earphone being worn by the user according to another embodiment of the invention. Referring to FIG. 2 and FIG. 4 together, before the user takes the earphone 200, the sensor 260 obtains three-dimensional (3D) data TD1 of a first position for the earphone 200 (as shown in label 410), wherein the 3D data TD1 comprises axis information regarding X axis, Y axis and Z-axis of the earphone 200. Next, the user takes the earphone 200 and puts it on his head (as shown in label 440) via a second position (as shown in label 420) and a third position (as shown in label 430) in sequence. Moreover, the sensor 260 also obtains the 3D data TD2 corresponding to the second position, the 3D data TD3 corresponding to the third position, and the 3D data TD4 that the earphone 200 is being worn, respectively. Thus, the sensor 260 provides the movement path Spath to the controller 250 according to the 3D data TD1-TD4. Therefore, when the movement of the earphone 200 has stabilized, the controller 250 can determine that the earphone 200 is being worn completely, and the controller 250 can determine that the user takes and wears the earphone 200 via his left side according to the movement path Spath. Then, the controller 250 assigns the correct sound channel signals to the speakers 270 and 280.

As described above, the controller 250 of FIG. 2 can obtain the movement direction and the movement distance of the earphone 200 according to the movement path Spath of the earphone 200. Therefore, in certain situations, the controller 250 will keep the previous setting of the control signal SW, and will not provide a new control signal SW to the switching unit 240. For example, when the user wears the earphone hung around the neck to the head, the movement distance is shorter than usual (i.e. from the neck to the head). Therefore, if the controller 250 determines that the movement distance of the earphone 200 is shorter than a specific distance, the setting of the control signal SW is maintained. Furthermore, if a first user helps a second user to put on the earphone from the rear, such as an adult removing the earphone from his head and putting it on a child's head, the controller 250 can detect that the movement direction of the earphone is down. Therefore, if the controller 250 determines that the movement direction of the earphone 200 is a specific direction, the setting of the control signal SW is maintained. Furthermore, if the earphone is a circumaural-type earphone, the sensor can be implemented in each earflap, to further detect an opening angle of the corresponding earflap, so as to determine whether the earflap is wearing in progress (a large opening angel) or is used (a small opening angel). Thus, the operational behavior of the user can be determined.

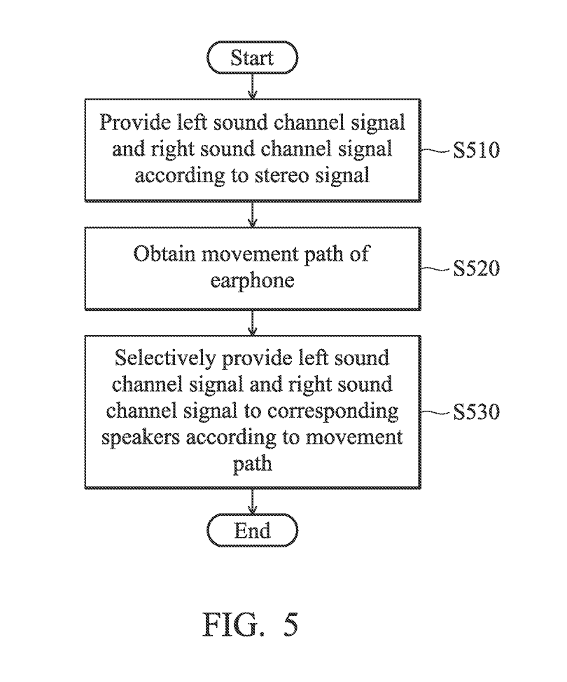

FIG. 5 shows a sound channel control method for an earphone according to an embodiment of the invention. Referring to FIG. 1 and FIG. 5 together, first, in step S510, the earphone 20 receives the stereo signal Saudio from the portable electronic device 10 with a wire or in a wireless manner, and provides the left sound channel signal Ch_L and the right sound channel signal Ch_R according to the stereo signal Saudio. Next, in step S520, the movement path Spath of the earphone 20 is obtained by the sensor, so as to determine a relative position between each speaker of the earphone 20 and the user, i.e. the speaker is near the user's left or right ear. Furthermore, as described above, according to the movement direction and the movement distance of the movement path Spath, the previous sound channel setting can be maintained. Next, in step S530, according to the movement path Spath, the left sound channel signal Ch_L and the right sound channel signal Ch_R are selectively provided to the corresponding speakers for playing.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An earphone, comprising:
a first speaker;
an audio processor, providing a left sound channel signal and a right sound channel signal according to a stereo signal;
a sensor, sensing a movement path of the earphone; and
a controller, selectively providing one of the left sound channel signal and the right sound channel signal to the first speaker according to the movement path.

2. The earphone as claimed in claim 1, further comprising:
a second speaker; and
a switching unit coupled to the first speaker, the second speaker, the controller and the audio processor, providing the one of the left sound channel signal and the right sound channel signal to the first speaker and providing the other of the left sound channel signal and the right sound channel signal to the second speaker according to a control signal from the controller,
wherein the controller generates the control signal according to the movement path.

3. The earphone as claimed in claim 1, wherein the sensor is a gravity sensor, a gyroscope, or an E-compass, and the movement path comprises a movement direction and a movement distance of the earphone.

4. The earphone as claimed in claim 3, wherein when the movement direction is a specific direction or the movement distance is shorter than a specific distance, the controller continues providing the one of the left sound channel signal and the right sound channel signal to the first speaker.

5. The earphone as claimed in claim 1, further comprising:
a wireless module, receiving the stereo signal from a wireless device, and providing the stereo signal to the audio processor.

6. The earphone as claimed in claim 1, wherein the earphone is a circumaural-type earphone, and the first speaker is disposed on an earflap of the circumaural-type earphone, and the sensor further detects an opening angle of the earflap to determine whether a user is wearing the earphone.

7. A sound channel control method for an earphone, comprising:
providing a left sound channel signal and a right sound channel signal according to a stereo signal;
sensing a movement path of the earphone; and
selectively providing one of the left sound channel signal and the right sound channel signal to a first speaker of the earphone according to the movement path.

8. The sound channel control method as claimed in claim 7, further comprising:
providing the other of the left sound channel signal and the right sound channel signal to a second speaker of the earphone according to the movement path.

9. The sound channel control method as claimed in claim 7, wherein the earphone comprises a gravity sensor, a gyroscope, or an E-compass for sensing the movement path of the earphone, and the movement path comprises a movement direction and a movement distance of the earphone.

10. The sound channel control method as claimed in claim 9, further comprising:
continuing providing the one of the left sound channel signal and the right sound channel signal to the first speaker when the movement direction is a specific direction or the movement distance is shorter than a specific distance.

11. The sound channel control method as claimed in claim 7, further comprising:
receiving the stereo signal from a wireless device via a wireless module of the earphone.

12. The sound channel control method as claimed in claim 7, further comprising:
detecting an opening angle of an earflap of the earphone, to determine whether a user is wearing the earphone,
wherein the earphone is a circumaural-type earphone, and the first speaker is disposed on the earflap of the circumaural-type earphone.
